(19) United States
(12) Patent Application Publication
(10) Pub. No.: US 2003/0204500 A1
(43) Pub. Date: Oct. 30, 2003

(54) Process and apparatus for automatic retrieval from a database and for automatic enhancement of such database

(76) Inventor: Jean-Francois Delpech, Limours (FR)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/422,222

(22) Filed: Apr. 24, 2003

Related U.S. Application Data
(60) Provisional application No. 60/390,247, filed on Jun. 20, 2002.

(30) Foreign Application Priority Data
Apr. 25, 2002 (FR) 02 05193

(51) Int. Cl. G06F 17/30

(52) U.S. Cl. 707/3

(57) ABSTRACT

The system comprises an interface for acquiring an initial request in natural language, which request is sent to a server of a main database, a storage memory for storing information searching methods, specialized modules for implementing searching methods, a module for responding to the initial request to produce metarequests, said module comprising a unit for extracting the most meaningful words or expressions from the initial request, a search engine for accessing an additional database, a unit for processing the metarequests in order to adapt them to the search engine, a unit for sending the processed metarequests to the search engine giving access to the additional database in order to obtain additional documents corresponding to the initial request, and a unit for transmitting additional documents to the specialized module for processing and formatting which then transmits processed and formatted information to the server in order to enrich the main database.

The present invention relates to a method and to a system for automatically extracting information contained in a main database and for automatically enriching the content of said database.

### BACKGROUND OF THE INVENTION

At present, numerous very vast and non-specialized databases exist that can be consulted by users having no previous experience of techniques for interrogating or for updating such databases.

The number of documents presently available on the Internet is several billion, and only a fraction are indexed by search engines. Even when restricted to public documents coming from the Internet, a database covering the fields of interest of an organization and accessible over its own Intranet can comprise millions of documents and can increase by several thousand new documents every day. Because of the strategic value of information and the importance of having information widely disseminated within the organization, it is necessary for consultation of said database to be as easy and as transparent as possible; it is also necessary for each day's (or hour's or week's) new information to be directed automatically and very selectively to the people to whom it is of interest.

Unfortunately, using very large databases is difficult at present for non-specialists since it usually requires inputting key words that characterize the subject (or that exclude other subjects); in addition, the results are very often presented in an order that appears to be arbitrary. Finally, periodic enrichment of said databases is performed either by systematically visiting predetermined Internet sites, or by manually inputting new documents, which is lengthy and tedious.

### OBJECTS AND BRIEF SUMMARY OF THE INVENTION

There therefore exists a need for an intuitive system for extracting information contained in very large databases so as to enable non-specialists to gain access very quickly to the documents that are of interest to them without it being necessary to use key words, and which also makes it possible for databases to be enriched automatically on a regular and effective basis as a function of the interests of users, without it being necessary for human operators to classify, index, create a thesaurus, or create a reference corpus.

The invention seeks to make it easy for users having no prior experience to consult very vast and unspecialized databases, and also to enrich said databases automatically in association with other accessible database sources, while preserving anonymity and confidentiality during information transfers, and in particular while navigating on an internal or an external network.

Another object of the invention is to provide a system which lends itself in particular to searching by analogy, i.e. searching for documents similar to a reference document, and to filtering, i.e. automatically classifying a set of documents thematically.

These objects are achieved by a method of automatically extracting information contained in a main database and of automatically enriching the content of said database, the method comprising the following steps:

a) presenting and sending to a server at least one initial request in natural language and of arbitrary length;

b) implementing a search method in a specialized module, the search method being suitable for defining a list of documents obtained from the main database in the context of the initial request;

c) on the basis of the initial request, producing at least one metarequest constructed by extracting the most meaningful words or expressions from the initial request, the metarequest serving to perform an additional search on at least one other, additional database, using at least one search engine, to find additional documents corresponding to the initial request; and

d) transmitting said additional documents to a specialized processing and formatting module which transmits processed and formatted information to the server in order to enrich the main database.

The other, additional database may be accessible via a network of the Intranet or Internet type.

According to a particular feature of the invention, the various metarequests used for additional searches in at least one other, additional database using at least one search engine are sent in an order that is arbitrary and random so as to prevent unauthorized reconstruction of an initial request solely from the stream of metarequests.

Advantageously, the method includes a test step consisting, for each initial request, in authorizing metarequests to be sent to at least one other, additional database using at least one search engine only if the initial request in question enables a number N of different metarequests to be generated where the number N is greater than or equal to a predetermined integer N₀.

Preferably, the method includes a step of verifying the mixing of metarequests in order to prevent a metarequest from a given initial request being sent to at least one other, additional database, unless said metarequest is present simultaneously with a plurality of other metarequests corresponding to a plurality of other different initial requests.

These measures make it possible to ensure confidentiality and prevent third parties being able to make use of the metarequests to reconstitute the lines on which users are searching, while still enabling the main database of the users to be enriched automatically as a function of their needs as defined by the various metarequests.

The additional documents relating to a plurality of requests may be transmitted by a server to the specialized processing and formatting module in deferred manner.

In a particular embodiment, the metarequests are generated by analyzing the language of the request to identify words and groups of words or “expressions” that have logical connections between one another, and then retaining only those words or groups of words that are representative of the request.

The words or groups of words that are retained as being representative of the requests may advantageously be selected as a function of their rarity.

According to another aspect of the method of the invention, after the step of presenting and sending at least one initial request to a server, an automatic selection step is performed by the server to select an information searching method from a set of different searching methods as a function of the type and the presentation of the initial request, after which a specialized module is used to implement the selected searching method in order to define a list of documents obtained from the main database in the context of the initial request.

The set of different searching methods comprises at least a Boolean or extended Boolean type searching method and a statistical type searching method.

Automatic selection of the best search method is an important advantage for databases that are to be consulted by non-specialists.

According to yet another aspect of the invention, a step is also performed of establishing “extemporaneously” a summary of each of the documents in the list of documents obtained in the context of the initial request, the summary being obtained by extracting sentences or parts of sentences that are the most meaningful compared with the initial request.

The search may also be performed in iterative manner, by successive approximations, by presenting new requests that take account of responses received to the preceding request.

Under such circumstances, the summary of a document obtained in the context of the preceding request may be used as the new request.

The presentation of a request in natural language of arbitrary length may be performed by an operation of the “cut/paste” type starting from a pertinent text.

In a particular implementation, the selected information searching method is selected as a function of a criterion constituted by the number of meaningful words in the request concerned.

Advantageously, the meaningful nature of a word is determined on the basis of the rarity of said word in the database.

According to a particular feature, the summary of a document is drawn up “extemporaneously” by making use of statistical data associated with the document and stored in the same file.

According to another aspect of the invention, the information for enriching the main database as processed and formatted by the specialized processing and formatting module is transmitted to the server if the additional documents specified by the search engine, after comparison with the initial request, presents a pertinent index that exceeds a predetermined threshold.

According to a particular feature, prior to drawing up a summary of each of the documents in the list of documents obtained in the context of a request, each document that has been gathered has been put into canonical form with a first version that is in its original form, a second version transformed into ordinary text suitable for drawing up a summary and for indexing, an http header, and line by line indexing, these various kinds of information being compressed in a single file.

The invention also provides a system for automatically extracting information contained in a main database and for automatically enriching said database, the system comprising:

a) means for acquiring at least one initial request in natural language and of arbitrary length;

b) means for sending said request to a server of the main database;

c) at least one storage memory for storing at least one information searching method;

d) at least one specialized module for implementing at least one information searching method stored in said storage memory;

e) a module for responding to an initial request by producing at least one metarequest, the module comprising means for extracting the most meaningful words or expressions from the initial request;

f) at least one other, additional database source;

g) at least one search engine for accessing said other, additional database source;

h) means for processing metarequests to adapt them to said search engine;

i) means for sending processed metarequests to said search engine that provides access to said other, additional database source in order to obtain additional documents corresponding to the initial request; and

j) a unit for transmitting additional documents to a specialized processing and formatting module which transmits processed and formatted information to the server for enriching the main database.

According to a particular feature, the system comprises mixer means connected to the module for producing metarequests in order to send different metarequests for use in additional searches on at least one other, additional database source by means of at least one search engine in an order that is arbitrary and random.

The system may include a unit for counting the number N of metarequests generated for a single initial request by the metarequest production module, a comparator unit for comparing the number. N of generated metarequests with a predetermined number N₀, and an authorization unit connected to the comparison unit to authorize or not authorize the sending of the N metarequests generated for a single initial request, as a function of the result supplied by the comparator unit.

The mixer means comprise a unit for verifying the mixture of metarequests, said means including means for identifying the initial request to which each metarequest belongs.

Advantageously, the system includes a plurality of specialized modules for implementing different information searching methods stored in said storage memory, and means for automatically selecting from said memory in order to enable the server to act as a function of the type and the presentation of the initial request to select an information searching method from the set of different information searching methods stored in said memory.

It may further comprise a module for establishing “extemporaneously” a summary for each of the documents in the list of documents obtained in the context of the initial request, said module comprising means for extracting the sentences or parts of sentences that are the most meaningful compared with the initial request.

### BRIEF DESCRIPTION OF THE DRAWINGS

Other features and advantages of the invention appear from the following description of particular embodiments given as examples and with reference to the accompanying drawings, in which:

FIG. 1 is block diagram showing some of the elements of a system for automatically extracting information and automatically enriching a main database;

FIG. 2 is a block diagram showing in greater detail an example of a document acquisition subsystem suitable for use in the FIG. 1 system;

FIG. 3 is a block diagram showing in greater detail an example of a document preprocessing and formatting subsystem suitable for use in the FIG. 1 system;

FIG. 4 is a block diagram showing a set of modules in a system for automatically extracting information and for automatically enriching a main database;

FIG. 5 is a flow chart showing some of the steps in the method of automatically extracting information and automatically enriching a main database;

FIG. 6 shows an example of the layout of a results window;

FIG. 7 shows an example of text being transferred to a search window; and

FIG. 8 shows an example of a results window for a new request.

### MORE DETAILED DESCRIPTION

In the invention, a main database may be enriched automatically from additional database sources while it is itself being interrogated by users. In the limit, the main database may initially be very small and may become very large only over time and as a result of being enriched automatically.

The documents gathered by various possible methods of acquisition are subsequently put into a canonical form and transferred to the main database, where they are made available to users. By “canonical form”, it should be understood that each document:

is available in its original form;

is transformed into ordinary text in order to make it easier to summarize and index,

is accompanied by its http header;

is indexed line by line; and

is compressed into a single file combining all of the above information.

The indexes of all of the documents added to the database are then concatenated and the program draws up and stores the list of all of the words present and of their occurrences, together with the weightings of the various documents (as needed for a full-text search by a statistical method, e.g. of the SMART type).

The architecture of the system for searching and presenting data comprises two nested elements: managing the individual operations; and the user interface.

At the core of the system there is a utility program which manages all of the individual operations associated with the inquiries transmitted by the client to the database, i.e. in particular setting up and managing filters (simple filters or comb filters) or creating summaries. This utility program is suitable for processing an arbitrary number of clients simultaneously. Its main function as exported to the user common gateway interface (CGI) receives as input the standardized request, the time range over which the search is to be carried out, the maximum number of documents that the response may contain, and finally the method of searching. In return, the CGI receives a list of documents classified in order of decreasing pertinence, together with a respective quality or pertinence index that depends on the pertinence of each response.

This utility program may use an “extended Boolean” search method in the sense that it does not make explicit use of Boolean operators which non-specialists find difficult to use, but that it takes account of all of the words in the request and of their weights (where rarer words have higher weights). The method itself determines all of the logic AND and OR operators implicit in the request and gives much greater (and parameterizable) weight to the AND operator. The quality index is normalized to unity, i.e. it is equal to 1.00 if all of the words of the request are present in a document with the same frequency, and vice versa, i.e. in practice when the request and the document are identical, and it becomes smaller and smaller as fewer and fewer words are present. This method of searching is particularly well adapted to the beginning of a search before the user has specified the exact field covered. An example of such an extended Boolean method is presented in the publication by Gerard Salton, Edward A. Fow, and Harry Wu: “Extended Boolean Information Retrieval”, Communications of the ACM, 26, p1022 (1983).

In the Boolean search method, the user constructs a request on the basis of key words connected together by logic operators (mainly OR, NOT, AND).

In its most common application, the results of the search (the documents which satisfy the logic condition expressed in the request) are presented to the user in an order that appears to be arbitrary. An ordered presentation in which the initial documents are those which appear in principle to be the most pertinent for the user is difficult to make compatible with the binary nature of Boolean logic, without resorting to other information such as the location of key words in the document, which often works quite well with standard documents such as dispatches from agencies, but which can sometimes lead to serious aberrations.

Another problem arises with words that are ambiguous: for example, on the Internet, an acronym can correspond to meanings that are very different and that can pollute the results of a naive search. Searching and classification are more and more often being improved by using a thesaurus or by taking word frequency into account (the least common words are, in principle, the most interesting, unless they happen to be typing mistakes . . . but the most common typing mistakes can be corrected . . . however, some rare words differ from common words merely by a single transposition of letters, and so on, which shows the limits of this method).

The Google search engine (http//www.google.com), which is doubtless the most effective search engine at present, appears to perform a Boolean search but orders the results of its search mainly as a function of the number and the quality of the Internet pages that point to the cited document; that method often gives remarkable results, but it is inapplicable to a closed database that is continuously being fed from a wide variety of sources.

The Boolean method suffers from a serious limitation: a key word which is not present in the request is not taken into account. In theory, it ought to be possible to construct a thesaurus or a list of synonyms making it possible to add key words automatically; in fact, that does not lead to results that are very satisfactory, except in situations of little practical interest where the database contains a small number of documents covering a well-defined domain.

The Boolean method is very fast, even on databases that are huge, and as mentioned above, it presents variants that enable the user to avoid having to use logic operators, and it is also well suited to classifying the documents obtained in order of decreasing pertinence.

The utility program can make use not only of Boolean methods, but also of other searching methods such as statistical methods, e.g. the SMART method, which is described in a publication by Gerard Salton and M. J. McGill, 1983, “Introduction to Modern Information Retrieval”, New York, N.Y., McGraw-Hill. A statistical type method such as the SMART method uses requests of arbitrary length.

That method gives good results in general use, when a thesaurus created by human operators is not available and when use is made of requests that are quite long.

In short, the SMART method determines the scalar products obtained by multiplying the request by the documents of the database in a space having as many dimensions as there are words in the language, and giving each word a weight that depends on its rarity in the database. The pertinence index of a document is the normalized scalar product of the request multiplied by the document, and it is equal to 1 if the request is identical to the selected document. That method gives results that are automatically classified in decreasing order of pertinence.

In principle, the SMART method suffers from the limitation that a key word which is not present in the request is not taken into account. In practice, providing the request is quite long (a sentence or even an entire document), this limitation vanishes because of the extreme redundancy of language.

That method requires computation time that is longer than the Boolean method since, in both cases, the time required is proportional to the number of words in the request (and depends little, in more or less logarithmic manner, on the number of documents). A SMART request can be much longer than a Boolean request, but methods of approximation make it possible to reduce computation time substantially (whereas by definition, the Boolean method must be exact). In any event, the time involved is negligible with present-day machines.

Concerning the user interface and processing requests, each time a client makes an inquiry, the server launches a program called retrieve.cgi which provides the interface between the utility program managing the individual operations and the requests transmitted by the client's navigator.

This program serves:

to modify user profiles independently (for example length of summaries, period covered, working language, automatic translation of search results);

to identify the user whose profile is stored in a directory (if the user so desires), which directory also stores a chronological list of that user's requests, thereby constituting the user's own personalized file; there is no limitation in principle on the number of users; and

to search by the most appropriate methods, which are generally selected by the program using heuristic criteria.

If the user so desires, the architecture of the system lends itself without difficulty to automatically translating the results of its searches.

Other client interfaces are also available for making periodic personalized information notes on the basis of comb filters made up by assembling together texts characterizing each tooth of the comb. Each user can modify the importance given to each tooth, the user's personal profile being contained in cookies exchanged between the server and the user's workstation.

The following can be mentioned as examples of periodic information notes:

a daily personalized information note based on the documents that have been added to the database in the latest 24 hours;

another filter is drawn up automatically on the basis of the six most recent requests from the client, and the client is also free to fix the priorities of each of the teeth of the comb corresponding to the requests;

a third comb filter can be drawn up automatically on the basis of texts describing the themes which the filter is to cover; and

a fourth filter is Boolean and comprises the names of about 200 businesses. The user is free to select which businesses to monitor and what appears on the user's screen corresponds to news concerning those businesses, presented in reverse chronological order and continuously updated, at the same time as the database.

This monitoring method is entirely automatic and adapts itself automatically and in evolving manner to the requests of clients.

The general operating principle of the system of the present invention is as follows:

1. The client sends a request to the server. This request may comprise one or more key words or a text of arbitrary length. The system may operate in a particular language, however multi-language operation is also possible by adding automatic translation modules.

2. Simultaneously, the client sends one or more cookies automatically to the server, e.g. for the purpose of specifying the number of responses desired, how they are to be satisfied, the semantic context of preceding questions, etc.

3. The server processes the client's request and returns the response, taking account of the information contained in the cookies and, where appropriate, modifies the cookies that are present on the client's computer.

4. In real time or in deferred time, the server sends the client's request to a subsystem which: (a) extracts the most significant words and groups of words (expressions) from the request; (b) constructs metarequests (made up of a set of individual requests generated automatically on the basis of a text in natural language) in order to search in an additional database that is accessible via a network of the Intranet or Internet type for additional documents corresponding to the client's request; and (c) transmits the pertinent documents to a pre-processing and formatting subsystem, which in turn (d) transmits them to the server in order to enrich the database.

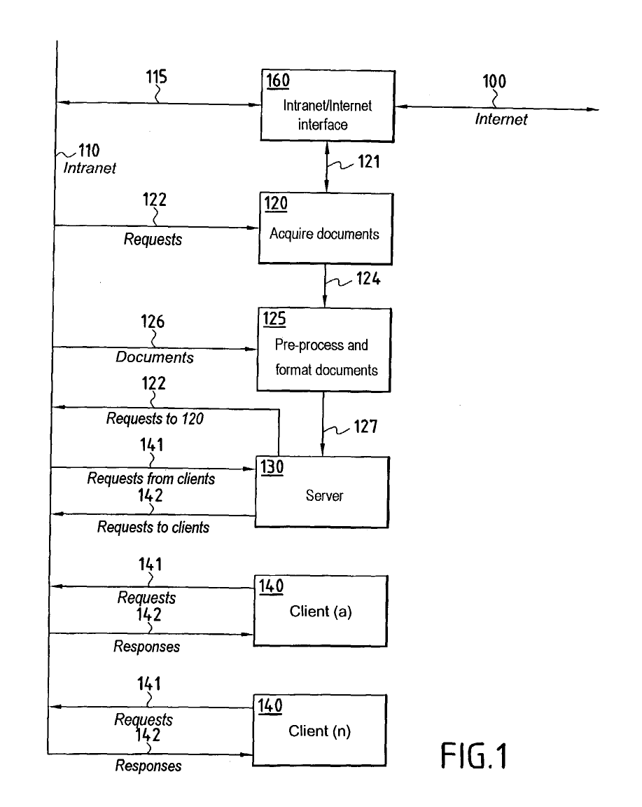

In one possible embodiment is shown in FIG. 1, the system of the invention is simultaneously connected to the Internet 100 and to the internal network 110 of the organization, referred to herein as the Intranet.

The network 110 could also be implemented in the form of an encrypted connection over the Internet (a virtual private network or “VPN”); if there are no security problems, the network 110 can even form part of the Internet, thereby allowing clients outside the organization to consult the server. Any other combination constituting an acceptable compromise between security and openness could naturally be devised.

The interface 160 between the Internet and the Intranet can provide real time operation through a firewall.

The data acquisition module 120:

receives client requests in real or deferred time over a link 122, which requests are transmitted thereto by the server 130 which has itself previously received these requests from clients 140 over links 141; and

contains a list of filters as described above. These filters amount to lists of requests to be formulated in repetitive manner, for example once every hour, day, or week.

By way of example, these requests may comprise:

monitoring Internet sets in order to detect new files and to import them if they satisfy certain criteria;

automatically acquiring articles from newspapers or journals, press communiques, agency dispatches; and

any other action of monitoring and/or tracking publications on the Intranet;

generates metarequests on the basis of clients' requests and of stored repetitive requests; and

uses such metarequests to access appropriate sites on the Internet in order to obtain pertinent documents and in order to transmit them over the link 124 to the subsystem 125 for pre-processing and formatting documents.

The module 125 for pre-processing and formatting documents receives the documents obtained by the module 120 over the link 124. Other documents (such as internal reports, for example) can be communicated to the module 125 by users internal to the business over the link 126.

The module 130 is the server; it contains the database with all of the information made available to the clients:

it receives the documents pre-processed by the module 125 over the link 127;

it processes user requests received over the link 141 and returns responses to them over the link 142; and

over the link 122, it sends user requests to the module 120; these requests are used to update the server's database in deferred time.

An arbitrary number of modules 140 can coexist; these are client workstations capable of sending and receiving http messages over the network and of storing cookies. They may be constituted by personal computers running a navigator, or by any other compatible equipment.

Some of the operations described above correspond to the actions undertaken by robots (“crawlers” and/or “spiders”).

Two original functions merit special attention, namely producing metarequests for searching for new documents as a function of the client's requests; and selecting amongst said documents those documents which are pertinent for enriching the database.

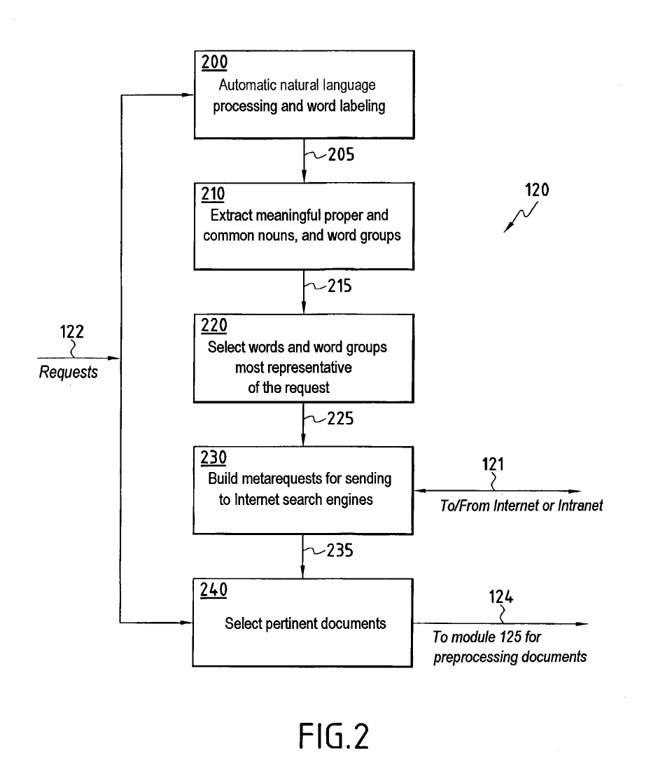

The module for producing metarequests on the basis of the requests processed by the subsystem operates as shown by the diagram of FIG. 2; it has its own modules 200, 210, 220, 230, but FIG. 2 also shows the selection module 240 in order to clarify the description.

The module 200 receives the request from the client, which, by way of example, might be a text comparing COIL and CO₂ lasers for cutting metals in which “COIL” is short of Chemical Oxygen-Iodine Laser. The words are labeled by natural language analysis techniques enabling each word to be associated with a label (e.g. V for a verb, N for a common noun, PN for a proper noun, A for an adjective, WALL for the end of a grammatically coherent sentence).

The module 210 receives the labeled text over the link 205 and retains the proper nouns, the common nouns, and the groups of words (expressions) which are potentially linked together logically, for example sequences A N, N N, N PN, etc.

These language processing techniques are described, for example, in the work by Christopher D. Manning and Heinrich Schütze “Foundations of Statistical Natural Language Processing” (second edition), 1999, Cambridge, Mass.: The MIT Press.

The module 220 associates each word received over the link 215 with its rarity (or weight) ρ=log N/(n+1), where N is the total number of documents present in the database of the server (which is periodically copied in the module 220), and where n is the number of documents in the database containing the word. A word that is very common, such as “ability”, thus has a value ρ close to zero, whereas a word that is rare or new has a high value for ρ. A sequence of key words is then constructed, e.g. by retaining the 24 words having the highest values for ρ that are present in the client's request. In the above-mentioned request relating to COIL and CO₂ lasers, the list might comprise, for example, “CO₂”, “YAG”, “optronic”, “helium”, “N₂”, “O₂”, but not the word “coil” which has several meanings and which is relatively frequent.

A sequence of key expressions is obtained in analogous manner, using the convention that the rarity ρ of a key expression is a square root of the sum of the squares of the rarities of its component words, i.e.

$$ρ = \sqrt{\sum {ρ}_{i}^{2}} .$$

Still using the same request, the list comprises, for example, expressions such as “cuts carbon steel”, “inert gas assist”, “Oxygen-Iodine”, “COIL lasers”, “kilowatt range”, etc.

Naturally, the number of key words is generally smaller than the number of words in the request, since very common words are always eliminated; the same applies to the number of key expressions, and it can happen that no key word or expression is selected if the client's request is too imprecise.

The module 230 receives the list of key words and expressions over the link 225 and combines these words and expressions so as to build up metarequests using the syntax required by each of the search engines consulted. These metarequests are sent to the search engines and the documents they mention are collected. It is thus possible to consult any of the search engines available on the Internet automatically, for example Google or the patent database Europat, however it is more efficient to select groups of search engines predetermined as a function of the substance of the original request from the client, with said substance being identified by the techniques described above. The module also contains lists of requests associated with filters created by clients.

The metarequests sent to the search engines contain only small pieces of information relating to the initial text; a text of several hundred words is typically represented by a dozen metarequests. Furthermore, the module 230 processes a very large number of requests simultaneously: naturally it processes new requests as a priority, and then by default it returns to old requests for the fairly common occurrence of new information becoming known to the search engines.

The stream of metarequests leaving the module 230 is thus large and depends simultaneously on numerous different requests: as a result, it is generally difficult to make use of said stream to reconstruct the purpose of any particular request.

By using additional means which form part of the invention, this can be made generally impossible. For this purpose, it is necessary to satisfy two conditions when processing a request R:

1. Metarequests may be sent to search engines only when the request R enables a sufficient number of metarequests to be generated, e.g. a dozen metarequests; and

2. The metarequests are classified in arbitrary order and they are not all sent simultaneously, but, for example, at a rate of only one metarequest per minute, while nevertheless guaranteeing that the module 230 remains active and processes numerous other requests at the same time as the request R.

The purpose of condition (1) is to spread the information contained in R over a sufficient number of metarequests. This has the consequence that the database cannot be enriched directly on the basis of a short request; nevertheless, because of the usually iterative nature of searching, this is not a drawback.

The purpose of condition (2) is to eliminate any information associated with the order of the metarequests and to further dilute information by ensuring that, at any instant, the information constitutes a negligible trickle in the total information stream sent to the search engines.

If the above two conditions are applied simultaneously to all of the requests, they guarantee overall confidentiality, providing the requests themselves are sufficiently varied; confidentiality is further improved with a large number of users having fields of interest that are different.

Experience shows that the metarequests as generated in this way from the client's original request are usually pertinent, and that in combination they nearly always enable the module 230 to find the original document on the Internet, providing it has already been indexed by one of the search engines used. Nevertheless, these requests also lead to numerous documents being collected that are not pertinent or that are of little pertinence, since the above lists contain words and expressions that are pertinent but not selective, for example “kilowatt range”.

The module 240 for selecting pertinent documents is, in fact, practically identical to the module for processing client requests as described below and incorporated in the server, except that this module makes use exclusively of the SMART statistical method since it always operates with full text. At the same time as the server or in deferred time, the module 240 receives the request from a client over the link 122 and compares it with all of the documents proposed to it by the module 230 over the link 235; only those documents having similarity with the request that exceeds a certain threshold (e.g. 0.20) are retained and sent to the pre-processing module over the link 124, together with http headers specifying where they come from. This module maintains a database of documents that it has already examined, and in order to save processing time it does not re-examine those which have already been sent to the server over the link 124.

The sequence of operations performed by the subsystem 120-125 serves to guarantee that the documents added to the database are pertinent.

The time which elapses between the arrival of a new request in the subsystem 120 and new documents being sent to the database is a function of four factors:

the time taken to analyze the request (modules 200, 210 and 220), which time is negligible even when the requests are long, e.g. several tens of kilobytes long;

the response time of the search engines, which time is generally also negligible;

the time needed to download the documents cited (module 230) which can be quite lengthy and which depends essentially on the speed of the sites containing said documents; and

the time required for comparing the request with all of the new documents (module 240).

In the vast majority of cases, it is the module 230 which limits overall performance, since certain sites can be difficult of access. In practice, e.g. using a 256 kilobit per second (kbit/s) link and a Pentium III, the time between the request arriving over the link 122 and the response over the link 124 is generally one to two minutes. Since the response times of the server are much shorter, a fraction of a second to a few seconds depending on the number of active clients, a client receives in real time a list containing only those documents that are already contained in the database. Nevertheless, if the client consults the database again a few minutes later with the same request, then the client's list will be enriched with the documents that have been produced by the subsystem 120.

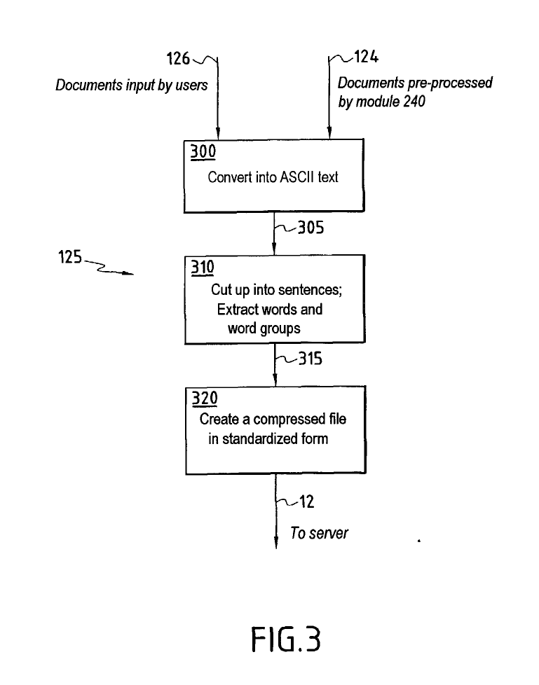

The subsystem 125 for pre-processing and formatting documents is shown in FIG. 3:

it receives over the link 126 documents supplied by users in a protocol that depends on the way in which the system of the invention is actually implemented. Sending might be direct from authorized users, or indirect after filtering by a documentation service, or by manual entry of documents recorded on a computer storage medium such as a floppy disk or a CD ROM; and

over the link 124 it receives the documents obtained by the module 120 together with their http headers.

Independently of their origin, these documents may be in any form whatsoever (Word files, Acrobat files, HTML documents, etc.); the only restriction is that the documents must contain text.

The module 300 converts each document into text (i.e. a sequence of ASCII characters), using operations that are well known in the art.

Over the link 305, the module 310 receives the original document, the document converted into text form, and any formatting information useful in distinguishing portions of the text (title, paragraphs, etc.). By analyzing the language of the text automatically and by making use of the resulting labeling of its words, the module 310 then subdivides the text into grammatically coherent sentences and extracts the words (e.g. “COIL” or “laser”) and the groups of words (e.g. “COIL laser”) from each sentence. These operations are identical to those performed in above-described modules 200 and 210.

The module 320 receives all of this information over the link 315, and for each document it creates a compressed file in a standard form (canonical form). This file having the generic file name document.zzp comprises in particular:

a header, itself comprising:

the norm of the document as is needed for using the SMART method;

a pointer to the beginning of the title;

a pointer to the beginning of the text of the original document,

a pointer to the beginning of the text in ASCII;

a pointer to the beginning of sentence by sentence dictionaries;

a pointer to the beginning of the list of groups;

a pointer to the end of the list of groups; and

the date at which the operation was performed;

the non-compressed title;

the text of the original document in compressed form;

the ASCII text in compressed form; and

the compressed sentence by sentence dictionaries.

Naturally, including text in the database, whether in original form or in ASCII, assumes that the database manager has, if necessary, obtained the right to store the text in electronic form from the copyright owner; in contrast, the other stored information cannot be used for reconstituting the text and merely represents statistical information needed for searching the document.

For a document that is subject to copyright, it may be that the user needs to pay royalties to the document owner. Under such circumstances, it suffices to use means well known in the art to add means device to the server (module 130) suitable for managing access to documents of this type and for paying royalties, while still leaving the other documents on free access.

It is also possible to replace the text of the document by a pointer giving its http address on the Internet, thus enabling the client to access it, if it is still available.

The server constituting the subsystem 130 of FIG. 1 performs two groups of functions:

1. Classifying Documents Formatted by the Module 125

(a) The server receives the documents over the link 127;

(b) It stores them in memory, e.g. on a hard disk, giving each a unique code of fixed length C_{doc} e.g. containing the date of processing, the category of the document (newspaper article, report, Web page, . . . ), its order number in the day, and any other information that is useful in managing the database; in the present description, this code is eight bytes long, but any other choice is possible, depending on requirements; and

(c) it indexes them and enriches the database by incorporating the resulting information therein.

2. Processing Client Requests

(a) It receives client requests by http over the Intranet via the link 141;

(b) Over the link 122, it sends these requests to the acquisition module, either via the Intranet, or else via any other means providing a sufficient degree of security; and

(c) It processes the requests, draws up summaries of pertinent documents and sends the responses to clients over the link 142.

The database in fact comprises two databases, a daily database and a cumulative database. The information corresponding to a document that has just arrived is stored “provisionally ” in the daily database, which is itself incorporated into the cumulative database once a day, e.g. overnight. This operation is relatively lengthy: its duration depends mainly on the length of the cumulative database and, for example, it may take about ten minutes using a Pentium III at 800 megahertz (MHz). Below this distinction is ignored since it does not change the algorithms in principle, but merely makes them slightly more complicated to implement.

Although grouped together in a single module referred to as a “server”, the corresponding functions, and indeed the files, could easily be distributed over an arbitrary number of machines, either to accelerate access to documents, or even to separate data depending on the degree of security required. These implementation details do not affect the substance of the invention and they are ignored below.

The functions of indexing and enriching the database (point 1c) and of processing requests for establishing summaries and for sending responses (point 2c) are described in detail below.

Indexing a document is very simple, since it makes direct use of information stored in the compressed file document.zzp produced by the module 320. The specific sizes given below correspond to a particular embodiment of the invention; they show that all of the indexing files are easily contained in central memory, regardless of the number of documents, thus making it possible to respond very quickly to client requests.

1. The norm W^{d} of document d as needed by the SMART method is stored in a random access file called rwhthash.hsh, using a hashing function in C_{doc}. This file comprises 12 bytes per document and, for a million documents, is easily held in central memory.

2. Each word present in the dictionary of the document is added to the general index of words in all the documents in the database; this index comprises three files: the first file (svdwords.idx) points to the beginning of each word in the second file (svdwords.loc), which contains all of the words concatenated in alphabetical order, and the third file (svdwords.val) contains, for each word, (a) the list of the C_{doc} codes containing the word, and (b) the corresponding numbers of occurrences. The first file svdwords.idx also contains pointers to the third file, giving a total of 12 bytes per word. Typically, with several hundred thousand distinct words, the sizes of the first two files are a few megabytes, and they are easily held in central memory. The length of the file svdwords.val, which remains on a hard disk or some other storage medium, is, for example, 720 megabytes in one particular embodiment (500,000 documents and 350,000 words), and it can be very useful to subdivide it into a plurality of files, for example as a function of the alphabetical order of words or as a function of their frequencies. These implementation details do not have any effect on the substance of the invention, and they are generally ignored below.

In many respects, the operations of processing requests make use of mechanisms that are conventional in client-server interaction, regardless of the protocol used. For convenience, the description below assumes that the http protocol is used, however that does not put any limit on the generality of the invention, which is compatible with any interaction protocol.

1. The request is initially put into canonical form; to do this, the words in the text of the request are identified and a list of words is drawn up together with their occurrence numbers; the list is classified by order of decreasing rarity in the database (i.e. the rarest words come first), with rarity being defined numerically by ρ=log N/(n+1), where N is the total number of documents present in the database of the server and n is the number of documents in which the word appears. To improve exhaustiveness, at the cost of a slight lack of precision, each word is processed as follows:

(a) Capitalization is ignored, i.e. the word is converted fully into lowercase;

(b) When letters are repeated, only the first letter is conserved;

(c) Terminal “s” is ignored, and terminal “ies” is replaced by “y”;

(d) Words of fewer than three letters are ignored;

(e) Very common words such as “the” and “also” are also ignored.

For example “Brussels” becomes “brusel”and “energies” becomes “energy”. Two other lists are drawn up simultaneously, where appropriate:

(a) The list of words that must be present in the documents retained (an a posteriori Boolean AND); and

(b) The list of words that must not be present in the documents retained (an a posteriori Boolean NOT).

These optional Boolean operators enable the client to improve the precision of a request, if so desired.

2. The optimum search method is selected automatically by using the following algorithm:

(a) If the request has fewer than eight words, the search is performed by the quasi-Boolean method;

(b) If the request has more than eight words, the request uses the SMART method.

Naturally, selecting a threshold of eight words is not critical, although that threshold does generally give good results.

Other known search methods may also be taken into account in addition to or instead of the methods mentioned above by way of example.

3. Finally, the list of pertinent documents classified in order of decreasing pertinence (or in chronological order depending on client preferences) is sent to the client. The details of the interface with the client are described below.

Concerning the operation of the document search software, interaction with the client can be provided by a conventional http server. Nevertheless, the invention does not depend in any way on using this standard and it could be implemented using any other standard.

The document search software is a CGI module called retrieve.cgi, or more briefly retrieve in the text below.

On starting up, retrieve stores the files bigsvd.wli, rwhthash.hsh, svdwords.idx, and svdwords.loc in central memory. Because these files are present in memory, search operations are usually very fast since they amount to no more than:

performing a binary search of a data storage medium in the file svdwords.val using the indexes svdwords.idx and svdwords.loc, when performing the extended Boolean method; or

performing two binary searches of a data storage medium in the files svdwords.val and rwhthash.hsh, when performing the SMART method.

When performing an extended Boolean search, retrieve:

1. draws up a list of all the documents that contain the words of the request (which request has a total of N_{words}) words);

2. eliminates those documents which do not satisfy conditions that the client might have given (documents lying outside a selected time range, documents that do not contain obligatory words, documents that do contain forbidden words, with this list naturally not being limiting);

3. gives the document d a weight P_{d} equal to the product of the rarities ρ of the words of the request that are present in the document;

4. calculates the norm N of the request in the same manner;

5. classifies the documents in order of decreasing weight P; and

6. finally gives each document d a quality index Q^{d} such that

$${Q}_{d} = ( exp \frac{log \frac{{P}_{d}}{N}}{{N}_{words}} ) / {Q}_{o} with {Q}_{o} = exp \frac{log \frac{{P}_{o}}{N}}{{N}_{words}}$$

Q_{d}≦1 since the documents are ordered by decreasing weight. It can be seen that this method does indeed favor the documents that are the closest to the request; in particular, those which contain N words of the request are more likely to precede those that contain N−1 words, particularly if the extra word is rare.

The algorithm for searching using the SMART method is not very different from that described above, however it includes an approximation which considerably shortens computation time;

1. The exact norm N of the request is initially calculated

$$N = {\sum }_{i = 1}^{{N}_{words}} {ρ}_{i} {r}_{i}^{2}$$

where rᵢ is the number of occurrences of word i in the request.

2. For each word j of the request, the words are stored in order of decreasing rarity.

(a) the contribution Nⱼ of words 1 . . . j to the norm of the request is calculated

$${N}_{j} = {\sum }_{i = 1}^{j} {ρ}_{i} {r}_{i}^{2}$$

and

(b) the same contribution Sⱼ^{d} of the words 1 . . . j to the non-normalized similarity between the request and each document containing the word j is also calculated,

$${S}_{j}^{d} = {\sum }_{i = 1}^{j} {ρ}_{i} {r}_{i} {q}_{i , d}$$

where q_{i,d} is the number of occurrences of word i in document d. Computation is stopped when the ratio Nⱼ/N exceeds a predefined threshold (e.g. 0.85), which constitutes the approximation of rank k≡j. At this point, the contributions Sₖ^{d} contain the approximations of rank k of the non-normalized similarities between the request and potentially pertinent documents in the database; the exact value of the non-normalized similarity of document d is clearly obtained if k≡N_{words}, i.e.

$${S}^{d} ≡ {S}_{NWords}^{d} .$$

The contributions Sₖ^{d} differ significantly from zero only for a very small subset D of the set of documents, and it is assumed implicitly below that d designates an element of D.

3. For each document dεD, the norms W^{d} are obtained from the file rwhthash.hsh.

If the non-normalized similarity S^{d} between document d and request r were known, then the normalized similarity σ(d,r) would be:

$$σ ( d , r ) = \frac{{S}^{d}}{\sqrt{{W}^{d} N}} ,$$

In fact S^{d} is not known, but it is reasonable to assume that it is often well approximated by

Ŝ^{d}=Sₖ^{d}N/Nₖ

in which case, the approximate normalized similarity is

$${Q}_{d} = \hat{σ} ( d , r ) = \frac{{\hat{S}}^{d}}{\sqrt{{W}^{d} N}} = ( {S}_{k}^{d} / {N}_{k} ) \sqrt{N / {W}^{d}}$$

where 0≦Q_{d}≦1 is the quality index, i.e. the pertinence of the document.

4. The module retrieve finally returns the list of documents, classified by order of decreasing pertinence, with a cutoff at a threshold lying in the range 0.1 to 0.15.

This method makes it possible to accelerate Salton's original method considerably for two reasons: firstly, because the number of words retained is smaller, e.g. by a factor of 1.5 or 2, and above all because the total number of documents to be taken into account is much smaller, since it increases as the exponential of the inverse of the rarity ρ of the words.

This increase in speed, usually by a factor of about ten, makes it possible to use the SMART method effectively with very large databases. Systematic tests have shown that the error introduced by this approximation is usually negligible.

Drawing up summaries of pertinent documents constitutes an important aspect of the present invention.

For practical reasons, the module retrieve returns only a list comprising δ documents, from d to d+δ−1, where the ordinal number d of the starting document and the number δ of documents returned are fixed by the client's request.

The module retrieve associates each returned document with a summary drawn up on the basis of document.zzp; to do this

1. the module extracts the ASCII text from document.zzp;

2. the module determines the similarity between the request and each sentence; and

3. the module creates the summary of the text by retaining, in order of appearance, the n sentences that are closest to the request. The number n of sentences that are retained (e.g. 4) is set by the client.

The summary is thus constituted by extracting the most significant sentences or sentence parts.

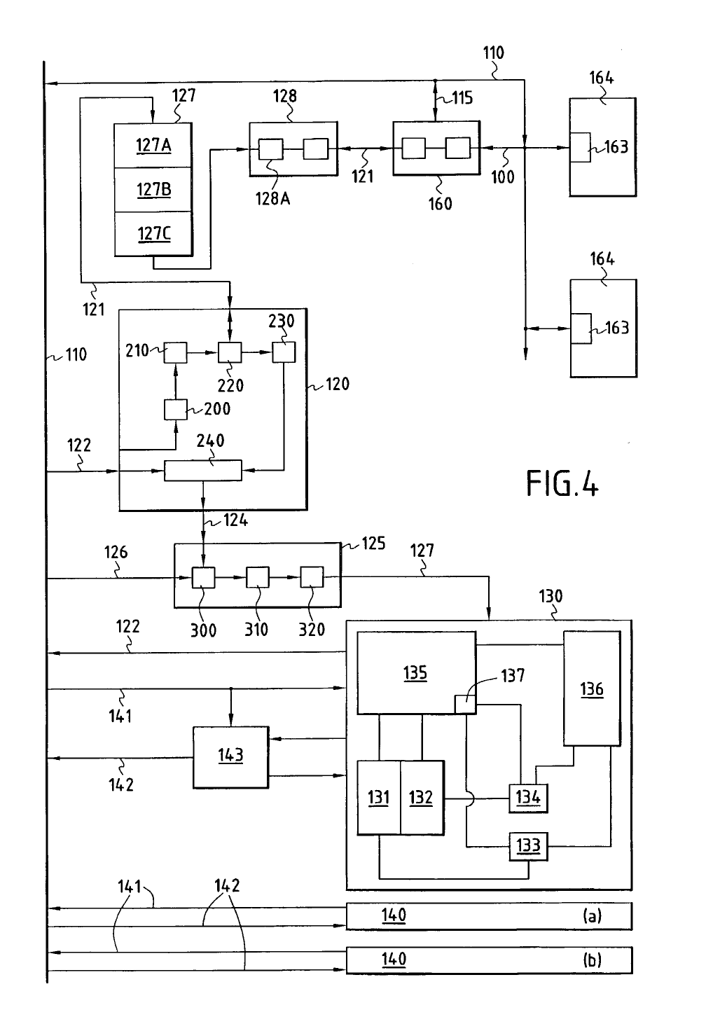

FIG. 4 summarizes all of the main component elements of a system of the invention enabling information contained in a main database 136 to be extracted automatically and enabling said main database 136 associated with a server 130 to be enriched automatically.

Reference 140 designates means enabling at least one request in natural language to be acquired from clients (a) to (n). Transmission means 141 enable requests to be sent to the server 130, e.g. over an Intranet.

In addition to the main database 136, the server 130 has a server central unit 135, storage memories 131 and 132 for storing various information searching methods, specialized modules 133, 134 for implementing respective different information-searching methods stored in the memories 131, 132, and means 137 for automatically selecting one of the different search methods stored in memory from the memories 131, 132 as a function of the type and the presentation of a request.

A module 143 associated with the server 130 enables a summary of each of the documents obtained in the context of the request that has been presented to be drawn up “extemporaneously”. Means 142 serve to transmit the results of the search together with the summaries drawn up by the module 143 to acquisition means 140 forming part of an interface with client users.

FIG. 4 also shows the document acquisition module 120 as described above with reference to FIGS. 1 and 2, with its subassemblies 200, 210, 220, 240, and the module 125 for pre-processing and formatting documents likewise described above, with reference to FIGS. 1 and 3, with its subassemblies 300, 310, 320.

FIG. 4 also shows, in more detail, the additional databases 164 that may be remotely located in an Intranet 110 or the Internet 100 and to which search engines 163 give access.

The interface 160 already shown in FIG. 1 comprises means 161 for processing metarequests to match them to the corresponding search engines 163 and means 162 for sending the processed metarequests.

Additional modules 127, 128 are associated with the interface 160 and with the document acquisition module 160, in particular with the subassembly 230 for building metarequests that are sent to search engines on the Internet.

The module 127 comprises: a sub-module 127A for counting the number N of metarequests created by the subassembly 230 on the basis of a request; a sub-module 127B comparing the number N with a threshold N₀; and a sub-module 127C constituting a unit for allowing the N metarequests generated for a given request to be sent in such a manner as to allow N metarequests to be sent to the module 128 only if N>N₀ (for example N₀ lying in the range 5 to 15).

The module 128 constitutes a mixer unit connected to the module 120 for producing metarequests through the module 127, so as to send out the various metarequests used for additional requests on an additional database 164 using a search engine 163 in an order that is random and arbitrary.

The mixer unit 128 takes account of metarequests coming from the various requests issued by different users (a) to (n) via the means 140.

In association with the means 162 for sending metarequests, the mixer unit 128 sends the metarequests in an order that is arbitrary and staggered over time, for example at a rate of one metarequest per minute.

The mixer 128 advantageously includes a subassembly 128A for verifying the mixture of metarequests and comprising means for identifying the requests from which each metarequest stems, so as to allow a metarequest to be sent out only if it is mixed in with other metarequests coming from other requests. These various requests may come from iterative requests stemming from the same initial request, or if a stricter constraint is applied, it may be necessary for the requests to come from different initial requests issued by different users or successively in time by a single user.

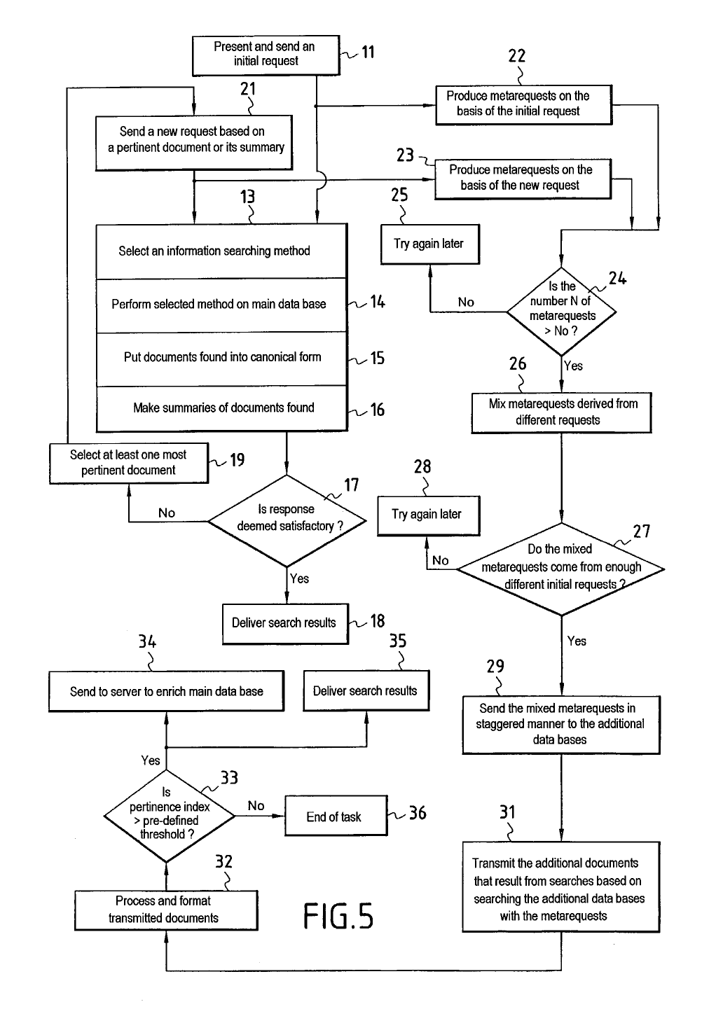

The main steps implemented in a method of the invention for automatically extracting information contained in a main database 136 and for automatically enriching said main database 136 associated with a server 130 are described below with reference to FIG. 5.

Step 11 consists in presenting and sending an initial request in natural language and of arbitrary length.

After step 11, step 13 consists in selecting an information searching method from a set of searching methods prerecorded in memory.

Step 14 consists in implementing the selected searching method in association with the main database 136.

Step 15 consists in putting the documents found in preceding search step 14 into canonical form.

Step 16 consists in drawing up summaries “extemporaneously” for the documents found in step 14 and processed in step 15.

Step 17 consists in a test to determine whether the response is deemed to be complete and satisfactory. If so, the method moves on to step 18, which consists in supplying the results of the search. Otherwise, the method moves on to step 19 for selecting at least one more pertinent document, and then moves on to step 21 which consists in sending a new request built up from a selected pertinent document or from its summary.

After step 21, steps 13 to 17 are performed with the new request as with the initial request. The test in step 17 makes a plurality of iterations possible, and as a general rule one or two iterations turn out to be satisfactory. Provision can also be made in the test of step 7 to select more than one pertinent document and to decide immediately to draw up a plurality of new requests on the basis of a plurality of selected documents, which are subjected to the processing of step 21 and of steps 13 to 17.

After steps 11 and 21, and while the processing of steps 13 to 17 is taking place, at least one metarequest is produced in steps 22 and 23 respectively on the basis of the initial request or on the basis of a new request. The metarequests constitute small elements of information relating to the initial text of the request in question expressed in natural language.

After metarequests have been produced in steps 22 and 23, a step 24 comprises a test which serves to determine whether the number N of metarequests is greater than a predetermined number N₀. If not, the method moves on to a step 25 for trying the test of step 24 later. Otherwise, if N>N₀, the method moves on to step 26 where metarequests coming from different requests are mixed together, and then to a step 27 which includes a verification test for determining whether the mixed-together metarequests have come from a sufficient number of different initial requests. If this is not the case, then the method moves on to a step 28 of waiting and trying the test of step 27 again later. In contrast, if the mixed-together metarequests do indeed come from a sufficiently large set of different initial requests, then the method moves on to step 29 in which the mixed-together metarequests are sent out in staggered manner to an additional database source 164 using a search engine 163.

After step 29, the method moves on to an optionally deferred transmission step 31 in which additional documents that result from searching the additional database 164 on the basis of the metarequests.

The following step 32 consists in processing and formatting the documents that have been transmitted.

Step 32 is followed by a step 33 consisting in testing to determine whether the pertinence index of the documents that have been processed and formatted is greater than a predefined threshold. If so, the method moves on to a step 34 of sending the processed documents to the server 130 in order to enrich the main database 136, and to a step 35 of delivering the results of the search. Otherwise, if the test of step 33 produces a pertinence index that is too small, the method moves on to a step 36 marking the end of the task, or where appropriate, to a new cycle of sending out metarequests at a later date in order to update the search in the additional database 164 on the basis of requests that have been presented successively in steps 11 and 21.

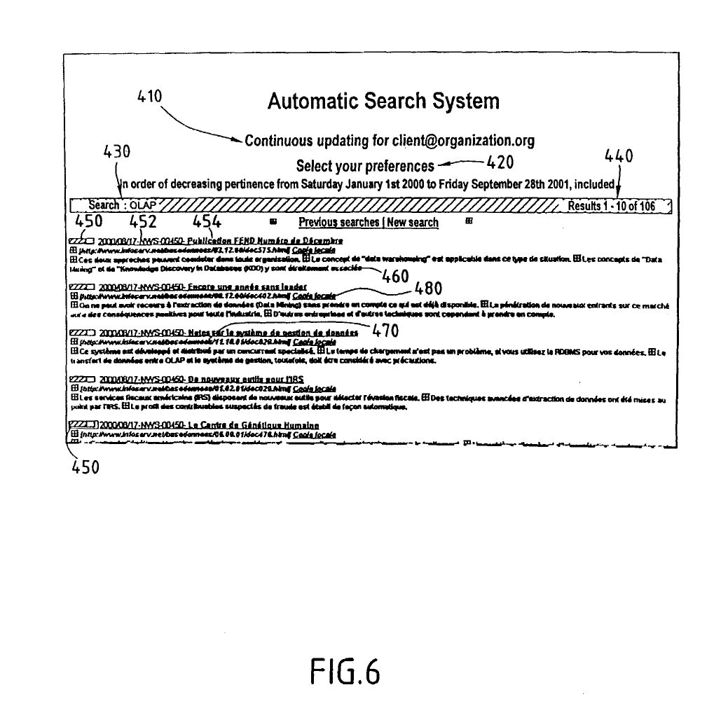

FIG. 6 shows an example of a results window in a user interface, having the following elements:

410 The results are personalized for a particular client, in this case client@organisation.org.

420 The client may modify preferences, for example the number of documents presented, the way in which they are ordered (chronologically or by decreasing pertinence), etc.

430 Reminder of the initial words in the request. In this case, the system is responding to the simple request “OLAP”; the search is thus performed using the extended Boolean method.

440 The first ten documents found (out of 106) are displayed on the screen in order of decreasing pertinence.

450 In front of each document, a colored scale represents its similarity index with the request (its pertinence, or its quality index).

452 The complete internal reference of the document.

454 The title of the document; by clicking on the title, the client can obtain the text of the document in ASCII, i.e. without formatting.

460 The summary in the meaning mentioned above, i.e. as drawn up “extemporaneously” and in this case comprising four lines; by clicking on the symbol [symbol] preceding each line of the summary, the client can obtain documents that are most similar to this line.

470 The http address of the original document; by clicking on the symbol [symbol] , the client can obtain the documents that are most similar to the original document.

480 By clicking on “local copy”, the client obtains the text of the document in its original formatting, as present in the file document.zzp in the database.

It should be observed that clicking on the symbol [symbol] enables the client to obtain more information by launching a new request on the basis of the text following the symbol: either the entire article, for the first line; or each of the lines of the summary.

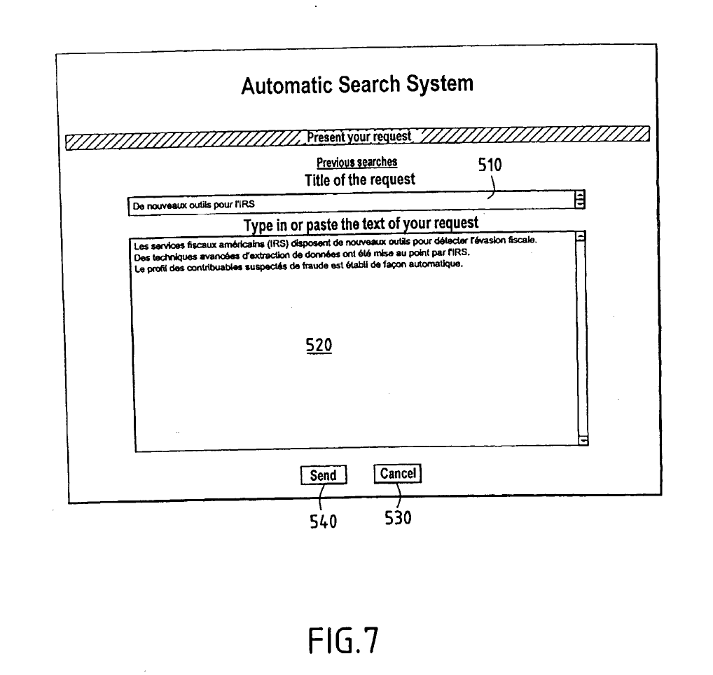

FIG. 7 shows an example of a search window in a user interface, this window making it possible to search by successive approximations. This window comprises the following elements:

510 An area containing the title of the request; this area which is of arbitrary length may also contain words that must not be included in documents (preceded by !!) and words that must be included in it (preceded by & &).

520 An area containing the text of the request.

530 A cancel button for use after making a mistake.

540 A button for starting the search.

Searching by successive approximations can be launched by clicking on the symbol preceding the address of a document or each of its lines.

Such a search may also be based on extracts from the document(s) found by the client to be the most interesting. The client need only “cut/paste” text from the document into the search window.

In particular, the client can thus transfer the summary of the document into the search window, usually giving excellent results: this is shown in FIG. 7 for the fourth document of FIG. 6, whose title has been transferred to the area 510 and whose text to the area 520 (a distinction between the title area and the text area is made for the convenience of the client, but it is entirely arbitrary; the same results are obtained if the same text is transferred solely to one or the other of these two areas).

It should be observed that this “cut/paste” method is also very useful in another method of searching where the user reads some document on a workstation and transfers a line, a paragraph, or even the entire text into the search window. This is generally the best way of launching a search: it is as simple as possible, while nevertheless being extremely precise and specific if the text is well chosen (otherwise it is still useful for searching by successive approximations).

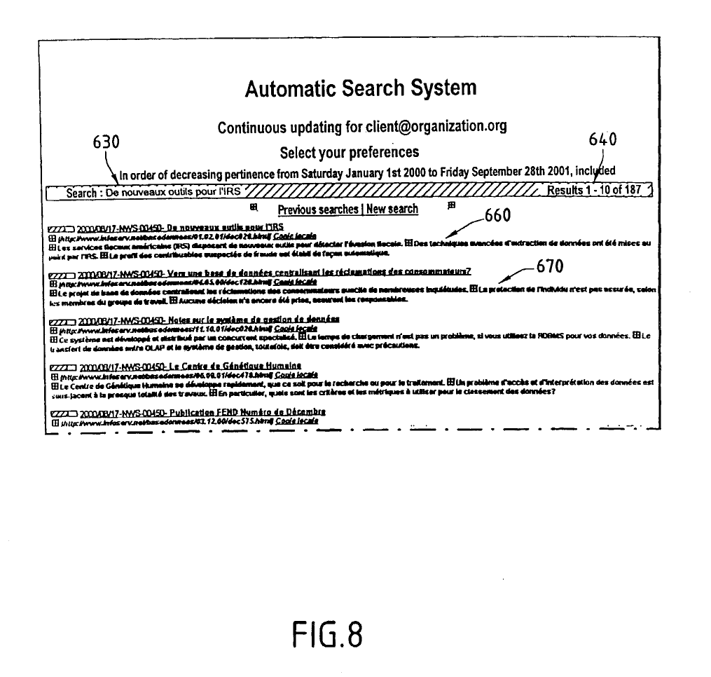

FIG. 8 shows the results of the new search shown in FIG. 7 and presented in a user interface. This figure shows the following elements:

630 Reminder of the initial words of the new request.

640 The rankings of the documents shown.

650 A colored scale of length proportional to the pertinence of the document.

660 The summary of the document that was used as the basis for the new request is the same as the summary that was the result of the first request.

670 The second document constitutes a new document which does not appear in the result of the first request.

What is claimed is:

1/ A method of automatically extracting information contained in a main database and of automatically enriching the content of the main database, the method comprising the following steps:
a) presenting and sending to a server at least one initial request in natural language and of arbitrary length;
b) implementing a search method in a specialized module, the search method being suitable for defining a list of documents obtained from the main database in the context of the initial request;
c) on the basis of the initial request, producing at least one metarequest constructed by extracting the most meaningful words or expressions from the initial request, the metarequest serving to perform an additional search on at least one other, additional database, using at least one search engine, to find additional documents corresponding to the initial request; and
d) transmitting said additional documents to a specialized processing and formatting module which transmits processed and formatted information to the server in order to enrich the main database.

2/ A method according to claim 1, wherein the other, additional database is accessible over a network of the Intranet or Internet type.

3/ A method according to claim 1, wherein the various metarequests used for additional searches in at least one other, additional database using at least one search engine are sent in an order that is arbitrary and random so as to prevent unauthorized reconstruction of an initial request solely from the stream of metarequests.

4/ A method according to claim 3, including a test step consisting, for each initial request, in authorizing metarequests to be sent to at least one other, additional database using at least one search engine only if the initial request in question enables a number N of different metarequests to be generated where the number N is greater than or equal to a predetermined integer N₀.

5/ A method according to claim 3, including a step of verifying the mixing of metarequests in order to prevent a metarequest from a given initial request being sent to at least one other, additional database, unless said metarequest is present simultaneously with a plurality of other metarequests corresponding to a plurality of other different initial requests.

6/ A method according to claim 1, wherein the additional documents relating to a plurality of requests are transmitted by a server to a specialized module for deferred processing and formatting.

7/ A method according to claim 1, wherein the metarequests are generated by analyzing the language of the request to identify words and groups of words or “expressions” that have logical connections between one another, and then retaining only those words or groups of words that are representative of the request.

8/ A method according to claim 1, wherein after the step of presenting and sending at least one initial request to a server, an automatic selection step is performed by the server to select an information searching method from a set of different searching methods as a function of the type and the presentation of the initial request, after which a specialized module is used to implement the selected searching method in order to define a list of documents obtained from the main database in the context of the initial request.

9/ A method according to claim 8, wherein the set of different searching methods comprises at least a Boolean or extended Boolean type searching method and a statistical type searching method.

10/ A method according to claim 1, wherein a step is also performed of establishing “extemporaneously” a summary of each of the documents in the list of documents obtained in the context of the initial request, the summary being obtained by extracting sentences or parts of sentences that are the most meaningful compared with the initial request.

11/ A method according to claim 1, wherein the search is performed in iterative manner, by successive approximations, by presenting new requests that take account of the responses received from the preceding request.

12/ A method according to claim 10, wherein the search is performed in iterative manner, by successive approximations, by presenting new requests that take account of the responses received from the preceding request, and wherein the summary of a document obtained in the context of the preceding request is used as the new request.

13/ A method according to claim 1, wherein the presentation of a request in natural language of arbitrary length is performed by an operation of the “cut/paste” type starting from a pertinent text.

14/ A method according to claim 8, wherein the selected information searching method is selected as a function of a criterion constituted by the number of meaningful words in the request concerned.

15/ A method according to claim 14, wherein the meaningful nature of a word is determined on the basis of the rarity of said word in the database.

16/ A method according to claim 10, wherein the summary of a document is drawn up “extemporaneously” by making use of statistical data associated with the document and stored in the same file.

17/ A method according to claim 1, wherein the information for enriching the main database as processed and formatted by the specialized processing and formatting module is transmitted to the server if the additional documents specified by the search engine, after comparison with the initial request, presents a pertinent index that exceeds a predetermined threshold.

18/ A method according to claim 10, wherein prior to drawing up a summary of each of the documents in the list of documents obtained in the context of a request, each document that has been gathered has been put into canonical form with a first version that is in its original form, a second version transformed into ordinary text suitable for drawing up a summary and for indexing, an http header, and line by line indexing, these various kinds of information being compressed in a single file.

19/ A method according to claim 7, wherein the words or groups of words that are retained as being representative of the request are selected as a function of their rarity.

20/ A system for automatically extracting information contained in a main database and for automatically enriching said database, the system comprising:
a) means for acquiring at least one initial request in natural language and of arbitrary length;
b) means for sending said request to a server of the main database;
c) at least one storage memory for storing at least one information searching method;
d) at least one specialized module for implementing at least one information searching method stored in said storage memory;
e) a module for responding to an initial request by producing at least one metarequest, the module comprising means for extracting the most meaningful words or expressions from the initial request;
f) at least one other, additional database source;
g) at least one search engine for accessing said other, additional database source;
h) means for processing metarequests to adapt them to said search engine;
i) means for sending processed metarequests to said search engine that provides access to said other, additional database source in order to obtain additional documents corresponding to the initial request; and
j) a unit for transmitting additional documents to a specialized processing and formatting module which transmits processed and formatted information to the server for enriching the main database.

21/ A system according to claim 20, further comprising mixer means connected to the module for producing metarequests in order to send different metarequests for use in additional searches on at least one other, additional database source by means of at least one search engine in an order that is arbitrary and random.

22/ A system according to claim 21, including a unit for counting the number N of metarequests generated for a single initial request by the metarequest production module, a comparator unit for comparing the number N of generated metarequests with a predetermined number N₀, and an authorization unit connected to the comparison unit to authorize or not authorize the sending of the N metarequests generated for a single initial request, as a function of the result supplied by the comparator unit.

23/ A system according to claim 21, wherein the mixer means comprise a unit for verifying the mixture of metarequests, said means including means for identifying the initial request to which each metarequest belongs.

24/ A system according to claim 20, including a plurality of specialized modules for implementing different information searching methods stored in said storage memory, and means for automatically selecting from said memory in order to enable the server to act as a function of the type and the presentation of the initial request to select an information searching method from the set of different information searching methods stored in said memory.

25/ A system according to claim 20, further comprises a module for establishing “extemporaneously” a summary for each of the documents in the list of documents obtained in the context of the initial request, said module comprising means for extracting the sentences or parts of sentences that are the most meaningful compared with the initial request.
